(19) United States
(12) Patent Application Publication
(10) Pub. No.: US 2026/0336842 A1
(43) Pub. Date: Oct. 29, 2026

(54) PAINTING DEVICE AND METHOD FOR PAINTING AT ELEVATION USING AN UNMANNED AERIAL VEHICLE

(71) Applicant: Air Constractive Ltd., Ganot Hadar (IL)

(72) Inventor: Moshe KIPNIS, Bitzaron (IL)

(73) Assignee: Air Constractive Ltd., Ganot Hadar (IL)

(21) Appl. No.: 19/707,497

(22) Filed: Jun. 15, 2026

Related U.S. Application Data
(63) Continuation of application No. PCT/IL2025/050451, filed on May 27, 2025.
(60) Provisional application No. 63/659,403, filed on Jun. 13, 2024.

(51) Int. Cl. B64U 30/30; B05B 13/00; B64U 101/28

(52) U.S. Cl. CPC B64U 30/30; B05B 13/005; B64U 2101/28

(57) ABSTRACT

A device and method to apply a fluid to a target surface at elevation. The device is supported by a line that is connected to an unmanned aerial vehicle (“UAV”). A housing that is engaged with the line. A housing has a nozzle that is in fluid communication with a ground based fluid resource. The housing has a control mechanism that uses a nonflammable pressurized fluid to adjust the pitch and yaw of the housing to deliver fluid to a target surface.

### RELATED APPLICATIONS

This application is a Continuation of PCT Patent Application No. PCT/IL2025/050451 having International filing date of May 27, 2025 which claims the benefit of priority under 35 USC § 119(e) of U.S. Provisional Patent Application No. 63/659,403 filed on Jun. 13, 2024. The contents of the above applications are all incorporated by reference as if fully set forth herein in their entirety.

### FIELD AND BACKGROUND OF THE INVENTION

The present invention, in some embodiments thereof, relates to delivering a fluid to a target surface and, more particularly, but not exclusively, to a target surface at elevation.

### SUMMARY OF THE INVENTION

According to an aspect of some embodiments of the present invention there is provided a fluid delivery device to a target surface at elevation comprising, a housing positioned at a required elevation by a support line connected to an anchoring point; a control mechanism based on pressurized nonflammable gas or liquid propulsion for changing at least one of horizontal position, pitch, roll and yaw of the device in relation to the target surface, the control mechanism attached to the housing; a fluid applier to deliver fluid to the target surface, the fluid applier connected to the housing; and a source of fluid connected to the fluid applier.

A second aspect of the invention there is provided in some embodiments a method for painting of target surface of a structure at elevation, comprising, hovering an aircraft in proximity to a target surface; supporting a painting device by a line at an elevation below the hovering aircraft; adjusting the elevation of the painting device; adjusting the at least one of horizontal position, pitch, roll and yaw of the painting device in relation to the target surface, the control mechanism attached to the housing; wherein the control mechanism uses pressurized nonflammable fluid propulsion; and delivering fluid with a paint applier to the target surface.

According to an implementation of the first aspect of the invention the anchoring point is configured to connect to an aircraft that is capable of hovering.

A further implementation of the first aspect of the invention external to the device one or more of a pressurized fluid supply source connected to the control mechanism, a fluid source connected to the fluid applier, and an electrical power source connected to the device.

Another implementation of the first aspect of the invention a camera or other sensor is connected to the control unit.

An implementation of the first aspect of the invention external to the camera a transparent flexible window or a multi-window is configured to be interposed in front of the camera.

Another implementation of the first aspect of the invention the window has a wiping mechanism to clean the window.

A further implementation of the first aspect of the invention the housing is configured to change the housing elevation on the support line to deliver fluid to a different target surface.

An implementation of the first aspect of the invention the housing elevation is changed by a winch connected to the support line positioned on one of the aircraft and the housing.

Another implementation of the first aspect of the invention the control unit has one or more monitoring sensors and working tools.

According to an implementation of the second aspect of the invention the step of supporting a painting device is at a distance from the hovering aircraft that is above paint aerosol.

A further implementation of the second aspect of the invention the proximity of the hovering aircraft to the target surface is an elevation above the structure.

An implementation of the second aspect of the invention the painting device is supported at a lateral distance within a range that is configured to deliver paint facing the target surface.

Another implementation of the second aspect of the invention adjusting the elevation of the painting device is adjusting the elevation of the hovering aircraft where the distance between the hovering aircraft and the painting device is fixed.

A further implementation of the second aspect of the invention the painting device has a sensor to establish the position of target surface relative to the painting device, the steps of adjusting the elevation, horizontal, yaw, and pitch of the painting device is determined by camera or other sensor. The camera or other sensor can be connected to the control.

Another implementation of the second aspect of the invention in the camera operates through a transparent and flexible window or a multi windows device, wherein a control mechanism is configured to interpose the window in front of the camera when the output of the camera is below a predetermined resolution.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system.

In an exemplary embodiment of the invention, one or more tasks according to exemplary embodiments of method and/or system as described herein may or are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a perspective cutaway view of the device installed with an unmanned aerial vehicle (“UAV)”.

FIG. 2 is a cutaway perspective view of the device housing.

FIG. 3 is another embodiment perspective cutaway view of the invention installed with a UAV;

FIG. 4 is a perspective cutaway view of the housing of the embodiment of FIG. 3.

FIG. 5A a perspective view of an embodiment with a camera on the housing with a flexible transparent window.

FIG. 5B is perspective view of the flexible transparent window of FIG. 5A.

FIG. 6 is perspective view of an embodiment for device in use with a structure with an overhang.

### DESCRIPTION OF SPECIFIC EMBODIMENTS OF THE INVENTION

The present invention, in some embodiments thereof, relates to delivering a fluid to a target surface at elevation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The technical problem is to deliver a fluid such as paint to a target surface at elevation without exposing workers or equipment to an aerosol cloud. A paint applier connected to the housing delivers the fluid to a target surface. The “paint applier” includes a nozzle, brush or other delivery of paint in liquid or aerosol form to the target area.

The solution is to use a UAV or any other aircraft that can hover to hover about the structure with the target surface. This allows the fluid to be delivered without fouling the UAV propellors or other equipment. The fluid can be paint, cleaning fluid, or insulation. “Fluid” is any liquid, gas or mixture.

Connected to the UAV is line that is supported by the UAV. One end of the line has an anchor or anchoring mechanism. The other end to the support line is connected to a housing of the device that is applying the liquid to the target surface. The separation of the UAV and the device also keeps UAV turbulence away from the target surface. allows for more uniform painting or other fluid deliver. The device is much smaller than supporting UAV and control mechanism has no moving parts such as motors and propellers, thus produces turbulence around it

Another technical problem is that where the aerosol paint or other fluid is flammable with the risk of fire, explosion, and occupation hazards. Where a UAV is used, the vehicle itself is a risk to ignite the aerosol from fluid delivery.

The present invention has a technical solution that separates UAV and the fluid delivery device and has a propulsion system that uses a nonflammable pressurized fluid. The hovering UAV elevation is above the fluid delivery device and any aerosol cloud. Therefore, the risk of fire and explosion is mitigated. A further mitigation is the control of the position of the device and that the fluid delivery device that controls the propulsion of the device. “Propulsion” includes a reaction mechanism which may include jets and nozzles directing a nonflammable pressurized fluid. The nonflammable fluid thus is in place of other propulsion system using electrical or other motors in proximity of an aerosol cloud, thus reducing the risk of fire and explosion.

The device thus has a housing that is attached to the UAV by a support line. The support line includes a cable or rope. The line material includes natural, artificial, woven, or twisted. Additionally, the support line can have a sheath.

The housing is place in position by a control mechanism that controls a pressurized nonflammable fluid used for propulsion. The control mechanism is connected and in communication with the propulsion outlets and controls the pitch and yaw of the housing. In some embodiments the propulsion is in opposition to the force of the fluid delivered to the target surface. The pressurized nonflammable fluid may be nitrogen, argon, air, and water or a mixture of one or more of these fluids.

The nonflammable pressurized fluid is directed by a control mechanism through one or more nozzles to direct the housing pitch and yaw. It also positions the housing towards and in proximity to the target area on the structure. The control mechanism may also be in communication with a valve to control the delivery of fluid to the fluid appliers.. The airborne valve in this embodiment is connected to the control mechanism.

A fluid applier delivers fluid to a target surface of a structure. The fluid applier may be a nozzle, brush, or aerosol dispenser. The fluid may be paint, cleaning fluid, insulation, water or other fluid. A source of fluid is connected to and in fluid communication with the fluid applier.

An additional embodiment of the present invention is that is one or more embodiments limit the weight carried airborne by the device than is controlled by the non-flammable pressurized liquid. Limiting the carried weight allows the UAV to remain aloft. Limiting the device weight reduces the control effort of the device control mechanism thrusters using non-flammable pressurized fluid. The supply in some embodiments is ground based. A conduit, hose or other hollow tube is between and in fluid communication with the paint applier and the ground based fluid supply.

Additionally, in some embodiments a ground based pressurized nonflammable supply also limits the weight carried by a UAV. The ground based pressurized fluid supply is connected and is fluid communication to the propulsion nozzles by a conduit, hose, or other hollow tube. In some embodiments the sources of the applied applier and the pressurized fluid source to the control mechanism are located apart from the device on the supporting aircraft

Another embodiment has a camera or other sensor aboard or adjacent to the housing. The camera is connected to the control mechanism. Optionally the camera may be connected to a control mechanism or user on the ground. The camera is protected with a window or multi window that is flexible and transparent. The window protects the camera from the delivered fluid. Optionally, the window has a wiping mechanism to allow a camera to maintain an image after exposure to the fluid delivered. This is especially important where the fluid is delivered results in an aerosol cloud.

In one embodiment, the elevation mechanism engages the line attached to the UAV. It may be winch that is attached to the housing or to the UAV. The elevation mechanism allows the UAV to maintain constant altitude in that the fluid delivery unit elevation is adjusted while the UAV remains stationary. This simplifies the operation of the UAV, which is an additional advantage over other fluid delivery systems.

The elevation mechanism can be positioned connected to the UAV or the fluid delivery unit housing. The housing climbs and descends on the line.

Another embodiment is for the elevation mechanism to be the UAV itself where the UAV changes it elevation and thus changes the elevation of the housing.

The control of the housing orientation by the propulsion system may be by a single connected to and in fluid communication with the pressurized fluid conduit. A One or more nozzles are connected to an angular director for the yaw to rotate the nozzle through an angular range normal to the support line. This angular range is defined as yaw. The propulsion system also directs the fluid delivery along an angular range parallel to support line. This angular range is pitch. The angular director may be a gimbal.

The control mechanism can push the device back and forth or left and right while tilting the support line or even change the horizontal location of the hovering aircraft directly through the line anchoring point or through a horizontal force amplifier that is connected to it.

The device may be used in combination with an electrically driven with a ground based electric power supply or with power supply from the carrying aircraft. The use of an external electric supply allows the UAV to remain airborne longer or indefinitely. the energy source from the device significantly reduces its weight by eliminating the need to carry batteries. By removing an airborne energy source, the weight and flight time of the UAV are extended to allow delivery of more fluid to a larger surface area.

The control unit may have a connection to a ground-based unit that may be wireless. A wireless connection may be by radio or other cell phone data service. In this way the control mechanism can be connected to a network to permit remote commands and monitoring of the actions of the fluid delivery unit.

While is contemplated that a camera is optionally attached to the housing, one or more sensors may be attached. The sensors may include flow meters for the propulsion system, flow meter for the fluid delivery, an Inertial Measurement Unit (IMU), proximity sensor the distance to the target surface or any other sensors as required for the entire device control. The sensors are communication with control mechanism.

When encountering an overhang, there problem is that the UAV cannot approach the target surface because of an overhang. The overhang creates a hazardous situation for the UAV, the persons in a structure, and bystanders on the ground. The technical solution is to have a rigid, non-rigid, flexible or semi-rigid member. The member can be connected to another hovering UAV to deflect the support line.

Preliminarily, the method steps described can be performed in a different order and is not limited to the stated order.

The method for painting of target surface of a structure at elevation, comprise hovering an aircraft, preferably a UAV in proximity to a target surface, a painting device such as the fluid delivery device previously described is supported by a line at an elevation below the hovering aircraft. The method adjusts the elevation of the painting device and adjusts the horizontal position, pitch, roll and yaw of the painting device in relation to the target surface. The adjustment of the painting device is by a control mechanism attached to a nonflammable pressurized fluid that directs jets or nozzle propulsion. The method then delivers fluid through a paint applier to a target surface.

Another step of the method is that the painting device is supported at a lateral distance within a range that is configured to deliver fluid facing the target surface.

The step of adjusting the elevation of the painting device is adjusting the elevation of the hovering aircraft. In this step the distance between the hovering aircraft on a support line and the painting device is fixed.

Another embodiment has adjusting the elevation of the painting device by an elevation adjusting mechanism engaging the support line to adjust the distance between the painting device and the hovering aircraft. This can be a winch or other device to move the device that is engaged with the support line.

Another step is to have a sensor to establish the position of target surface relative to the painting device having the steps of adjusting the elevation, horizontal, yaw, and pitch of the painting device is determined by camera or other the sensor connected to control mechanism.

The step with a sensor in another embodiment is a camera operating through a transparent and flexible window or a multi windows device. A controller is configured to interpose the window in front of the camera when the output of the camera is below a predetermined resolution.

Another embodiment delivers the fluid through a paint applier with one or more nozzles applying an aerosol paint.

Another embodiment is that the painting device paint supply is located apart from the housing. Preferably on the ground or on the carrying hovering aircraft.

A further embodiment is that and the control mechanism is on the ground and in communication with the device.

Another embodiment has the pressurized fluid supply are located apart from the painting device.

An additional step is to have the hovering aircraft above an aerosol cloud of the fluid such as paint that is delivered to the target surface. This reduces the risk of fouling the hovering aircraft.

Another embodiment is that the hovering aircraft is at an elevation above the structure. This reduces turbulence.

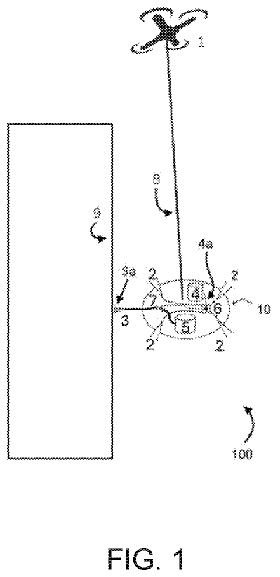

Referring now to the drawings, FIG. 1 is a simplified illustration the device 100 installed with a UAV 1 and attached support line 8. The housing 10 is connected to the support line 8. The housing 10 has a pressurized fluid container 4 and a fluid container 5. In FIG. 1 the housing is shown in a cutaway perspective view.

The fluid container 5 is connected and in fluid communication with the fluid applier 3, optionally valve 7 is interposed between the fluid container 5 and the fluid applier 3. The control mechanism 6 is connected by a cable valve 7.

The fluid applied is depicted as aerosol 3a is depicted at in another embodiment (not shown) more than one nozzle is provided. The multi-nozzle embodiment has a wider area of coverage of the target 9 area than a one nozzle embodiment. The housing 10 has a control mechanism 6 is connected and is in fluid communication with pressurized fluid container 4 and one or more nozzles or jets 2. The nozzles 2 are the point of origin of the pressurized fluid stream and not the illustrated cone of outflow. A pressurized fluid stream that is directed by the control mechanism 6 to control the position, pitch and yaw of the housing.

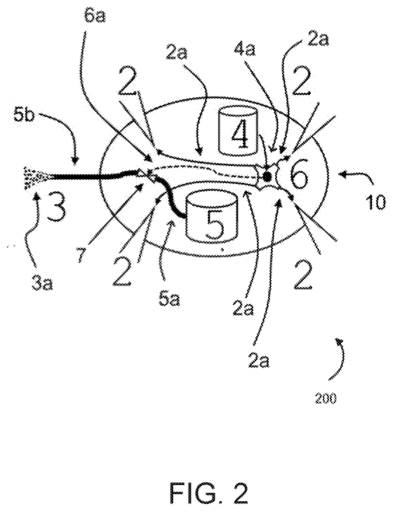

In FIG. 2 is a detailed cutaway view 200 of the housing 10. In this view, additional details are added to FIG. 1. Specifically, the connection between the pressurized fluid container 4 and the control mechanism 6 is designated as 4a. The connection 2a between the control mechanism and the propulsion nozzle or jets is shown. Control of the valve 7 cable 6a connects the control mechanism 6 and valve 7. Additionally, the fluid container 5 is connected to valve 7 by a conduit 5a. While not called out in FIG. 1, the same elements are present in as described in FIG. 2.

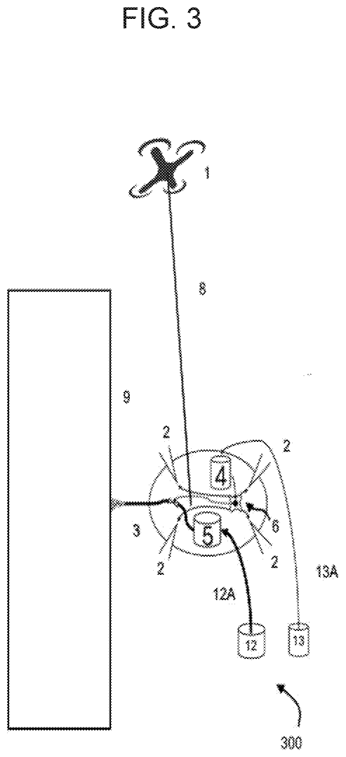

FIG. 3 is a simplified drawing of the invention 300 of this application illustrating the embodiment of FIG. 1 with the same reference numbers and with the addition of a ground based pressurized source 13 and a ground based fluid source 12. The ground based pressurized fluid source 13 is connected to the housing 10 based pressurized fluid container 4 by conduit, hose, or other hollow member 13a; and a ground-based fluid source 12 is connected to the housing 10 based fluid container 5 by conduit, hose, or other hollow member 12a.

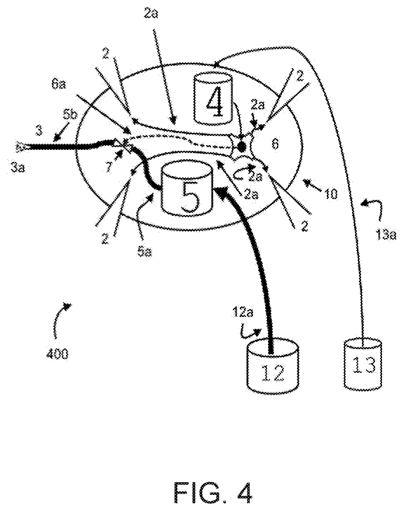

FIG. 4 is a cutaway view of the device 400 the housing 10 and ground-based fluid source 12 and ground based pressurized fluid source 13. In this view, the connections have the same reference numbers as FIG. 2 with the additional of the reference numbers of FIG. 3.

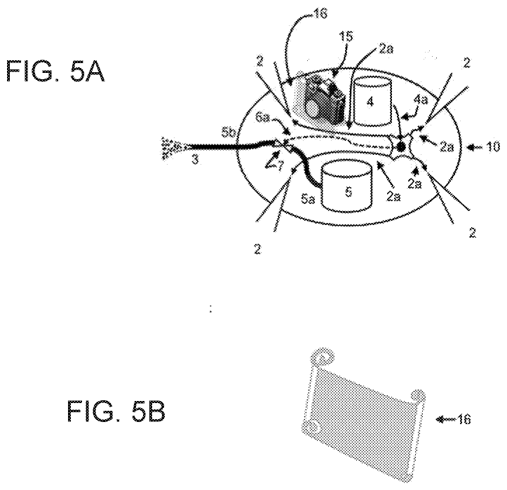

FIG. 5A is an embodiment of the invention of this application with the addition of a camera 15 that is protected by a flexible transparent rollable window 16. The window 16 may also be a plurality of windows.

FIG. 5B is a perspective view of the window 16 in an unrolled state. The window 16 can be rolled or retracted. A wiping mechanism is not shown.

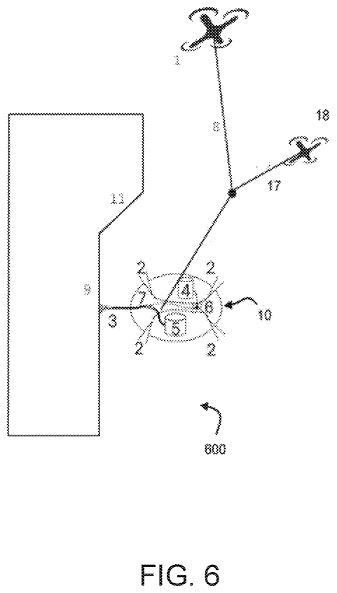

FIG. 6 is a perspective view of the device 600 is use with a structure having an overhang negative slope surface 11. A second UAV 18 hovers attached to a member 17 that deflects the housing 10. The member can be rigid, flexible, or slack. A wire to pull the housing 10 may also be used.

It is expected that during the life of a patent maturing from this application many relevant technologies that are within the disclosure will be developed and the scope of the term of the elements such as the control mechanism, wireless communication, and the like are intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

As used herein the term “method” refers to manners, means, techniques and procedures for accomplishing a given task including, but not limited to, those manners, means, techniques and procedures either known to, or readily developed from known manners, means, techniques and procedures by practitioners of the mechanical arts.

The use of the term UAV refers also to any manned or unmanned aircraft that can hover.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A fluid delivery device to a target surface at elevation comprising:
a housing configured to be suspended in the air at a required elevation by a support line connected at one end to an anchoring point on the housing and at a second end to a supporting device, the support line positioning the housing at a required elevation below the supporting device;
a control mechanism that uses pressurized nonflammable gas or liquid as its propulsion medium, the control mechanism having no rotors, propellers or propulsion motors, for changing at least one of horizontal position, pitch, roll and yaw of the housing in relation to the target surface, the control mechanism attached to the housing and comprising one or more nozzles directing the pressurized nonflammable gas or liquid to reposition the housing;
a fluid applier to deliver fluid to the target surface, the fluid applier connected to the housing; and
a source of fluid connected to the fluid applier.

2. A fluid delivery device according to claim 1, wherein the supporting device comprises an aircraft that is capable of hovering above the target surface and above fluid aerosol cloud.

3. A fluid delivery device according to claim 1, wherein propulsion fluid for the control mechanism, treatment fluid for the fluid applier, and electrical power for operation of the housing are supplied to the housing from sources external to the housing during operation.

4. A fluid delivery device according to claim 1, wherein a camera or other sensor are in communication with the control mechanism.

5. A fluid delivery device according to claim 4, wherein one of: (i) the camera operates through a transparent flexible window and (ii) a multi-window is configured to be interposed in front of the camera.

6. A fluid delivery device according to claim 5, wherein the window has a wiping mechanism to clean the window.

7. A fluid delivery device according to claim 1, wherein the housing is configured to change the housing elevation on the support line to deliver fluid to a different target surface.

8. A fluid delivery device according to claim 7, wherein the housing elevation is changed by a winch connected to the support line positioned on one of a hovering aircraft and the housing.

9. A device according to claim 1, wherein the control mechanism has one or more monitoring sensors and working tools.

10. A method for delivering a fluid to a target surface of a structure at elevation, comprising:
hovering an aircraft in proximity to a target surface, the aircraft positioned at an elevation above an aerosol cloud produced by fluid delivery to the target surface;
supporting a fluid delivery device by a line connected to a housing of the fluid delivery device, the fluid delivery device suspended at an elevation below the hovering aircraft;
adjusting the elevation of the fluid delivery device;
adjusting the at least one of horizontal position, pitch, roll and yaw of the fluid delivery device in relation to the target surface using a control mechanism attached to the housing, wherein the control mechanism uses pressurized nonflammable fluid propulsion as the only propulsion system of the housing and comprises no rotors, propellers or propulsion motors, the control mechanism directing the pressurized nonflammable fluid through one or more nozzles to reposition the housing; and
delivering fluid with a fluid applier to the target surface.

11. A method for delivering a fluid to a target surface of a structure at elevation according to claim 10, wherein the step of supporting the fluid delivery device is at a distance from the hovering aircraft and is above fluid aerosol.

12. A method for delivering a fluid to a target surface of a structure at elevation according to claim 10, wherein the aircraft hovers at an elevation above a top of the structure.

13. A method for delivering a fluid to a target surface of a structure at elevation according to claim 10, wherein the fluid delivery device is supported at a lateral distance within a range that is configured to deliver fluid facing the target surface.

14. A method for delivering a fluid to a target surface of a structure at elevation according to claim 10, wherein adjusting the elevation of the fluid delivery device is adjusting the elevation of the hovering aircraft, wherein the distance between the hovering aircraft and the fluid delivery device is fixed.

15. A method for delivering a fluid to a target surface of a structure at elevation according to claim 10, wherein adjusting the elevation of the fluid delivery device is by an elevation adjusting mechanism to adjust the distance between the fluid delivery device and the hovering aircraft.

16. A method for delivering a fluid to a target surface of a structure at elevation according to claim 10, wherein the fluid delivery device has a sensor to establish the position of target surface relative to the fluid delivery device, the steps of adjusting the elevation, horizontal, yaw, and pitch of the fluid delivery device is determined by camera or an other sensor.

17. A method for delivering a fluid to a target surface of a structure at elevation according to claim 16, wherein the camera operates through a transparent and flexible window or a multi windows device, wherein a controller is configured to interpose the window in front of the camera when the output of the camera is below a predetermined resolution.

18. A method for delivering a fluid to a target surface of a structure at elevation according to claim 10, wherein the fluid applier has one or more nozzles applying the aerosol fluid.

19. A method for delivering a fluid to a target surface of a structure at elevation according to claim 10, wherein the fluid delivery device fluid supply and the control mechanism pressurized fluid supply are located remotely from the housing.

20. A method for delivering a fluid to a target surface of a structure at elevation according to claim 10, wherein the delivered fluid is paint.
